(19) United States
(12) Patent Application Publication
(10) Pub. No.: US 2016/0004785 A1
(43) Pub. Date: Jan. 7, 2016

(54) WEB-BASED PLATFORM FOR CREATION AND DELIVERY OF DIGITALLY WRAPPED GIFT CONTENT

(71) Applicant: Giftly, Inc., Nashville, TN (US)

(72) Inventors: Gary Mazzone Peters, Nashville, TN (US); John Hall, Nashville, TN (US); John Zhang, Nashville, TN (US)

(21) Appl. No.: 14/790,735

(22) Filed: Jul. 2, 2015

Related U.S. Application Data
(60) Provisional application No. 62/020,325, filed on Jul. 2, 2014.

(51) Int. Cl. G06F 17/30

(52) U.S. Cl. CPC G06F 17/30905; G06F 17/30896

(57) ABSTRACT

A method is described herein comprising one or more applications running on at least one processor of a remote server for providing an electronic interface, wherein the electronic interface comprises a create page, a workbench page, and at least one editor. The method includes receiving through the create page a selection of a template corresponding to locations for content on an electronic presentation. The method includes providing the workbench page for the locations, wherein the workbench page provides search options for selecting content. The method includes receiving through the search options on the workbench page a selection of content for the locations and populating the locations with the corresponding selected content. The method includes receiving through the at least one editor edits to at least a portion of the selected content. The method includes using information of the template, selected content and edits to prepare and deliver the electronic presentation.

### RELATED APPLICATIONS

This application claims the benefit of U.S. Application No. 62/020,325, filed Jul. 2, 2014.

### TECHNICAL FIELD

The embodiments described herein generally relate to providing temporary use of on-line non-downloadable cloud computing software enabling users to design, digitally wrap and send digital gifts to others, namely, downloadable audio and video content, digital photographs and digital gift certificates

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows template carousel, under an embodiment.

FIG. 2 shows an example of browsing for content, under an embodiment.

FIG. 3 shows an example of browsing for content, under an embodiment.

FIG. 4 shows an example of a template, under an embodiment.

FIG. 5 show an example of a create page, under an embodiment.

FIG. 6 shows an example of a workbench, under an embodiment.

FIG. 7 shows an example of a finished collage, under an embodiment.

FIG. 8 shows an editor, under an embodiment.

FIG. 9 shows an editor, under an embodiment.

FIG. 10 shows an editor, under an embodiment.

FIG. 11 shows an editor, under an embodiment.

FIG. 12 shows a method for creating and sending an electronic presentation, under an embodiment.

### DETAILED DESCRIPTION

A company currently known as GiftBox comprises a user experience company. The company develops among other services a web-based digital gifting platform. The website differentiates itself by being a website focused on the experience of third parties rather than just the experience of the user under one embodiment.

One product of the company is a digital GiftBox. The service and/or platform for creating such digital product is hereinafter referred to as GiftBox, the GiftBox service or the GiftBox platform. The context of the term GiftBox as used herein indicates its meaning as the GiftBox company, the product or the platform/service. Note that the GiftBox platform may be branded under Give Token under an alternative embodiment.

A user may use the GiftBox service to create a GiftBox which a user may then send to another. Each GiftBox comprises an interactive digital wrapper component, a collage component, and a download/upload component under an embodiment.

Interactive Digital Wrapper: In order to see the collage (as further described below), the user must interact with a digital wrapper. The digital wrapper duplicates the physical concept of wrapping paper. As just one example, a user may click/swipe over an image to shred the “wrapper” image to reveal the content of the GiftBox below the “wrapping” paper.

Collage: The Collage is a collage of pictures, videos, and/or GIFs but embodiments are not so limited. The Collage may include additional picture, audio and/or video formats. The Collage may also be interactive and include slideshows, hyperlinks, hover/click activated text overlays.

Download/upload—Users purchase downloads through the GiftBox company download store or upload their own digital content and attach such content to a GiftBox (just like attaching attachments to a Gmail email) under one embodiment. The creator/user may also attach attachments like in an email, and the viewer may download said attachments.

Embodiments of the GiftBox platform are implemented through a website built on HTML5, CSS3, JavaScript, and/or PHP components.

Embodiments of the GiftBox platform may run on HTML5 browsers and mobile computing platforms including iOS™, Android™, and Windows Phone™.

The content, experience and functionality of the GiftBox platform may be tailored for use by businesses/entities including nonprofits, schools, hospitals, sports event organizers, universities, and charities. The GiftBox platform provides an ecommerce solution for the creation and delivery of digitally wrapped gifts.

The GiftBox platform is ideal for sale/gifting of Digital Media including: Music, Music Videos, Movies, TV Shows, Apps (iOS™ or Android™), Videogames, eBooks, Audio Books, Podcasts, Lectures, and eTickets (Sporting Events, Music Events, Movies . . . ). Under an embodiment, third party vendors may integrate GiftBox into their websites. For example, Amazon™ may add a click through to the GiftBox platform at checkout such that users may then use GiftBox to wrap the purchased item. In like fashion, a user my use open table to make a reservation and then gift it via GiftBox. Sport event organizers may also use the GiftBox to package promotional offers under the systems and methods described herein. As yet another example, a user may use Shazam™ to identify, purchase and giftwrap a song (using GiftBox).

The GiftBox platform also allows users to upload personal data and content for use in a GiftBox for delivery to a third party.

Under one embodiment, the GiftBox collage may hold numerous combinations of digital content including combinations of audio, image and video formats.

The GiftBox platform under an embodiment provides one or more of the following platform components:

### A Home Page

### Under One Embodiment a Home Page Header Provides

1.1.1 GiftBox graphic in upper left corner, when clicked goes to Home page.
1.1.2 “Home” link, when clicked goes to Home page.
1.1.3 “Log In” link, when clicked opens a model login dialog.
1.1.4 My Account, replaces the “Log In” link after user logs in. When clicked goes to the My Account page.
1.1.5 “About” link, when clicked opens a dialog with “about” text.
1.1.6 “Create” link, when clicked opens the Create page if user is logged in. If not, opens the Log In dialog.

### Under One Embodiment a Home Page Log In Provides

1.2.1 Log in overlay underneath “Log In” link at top of page.
1.2.2 Clicking on any button/link that requires log in will display a model login dialog in the center of the screen.
1.2.3 Logging in sets the login status which will replace the “Log In” link with a “My Account” link and a “Log Out” link.

### Under One Embodiment a Home Page Image Carousel Provides

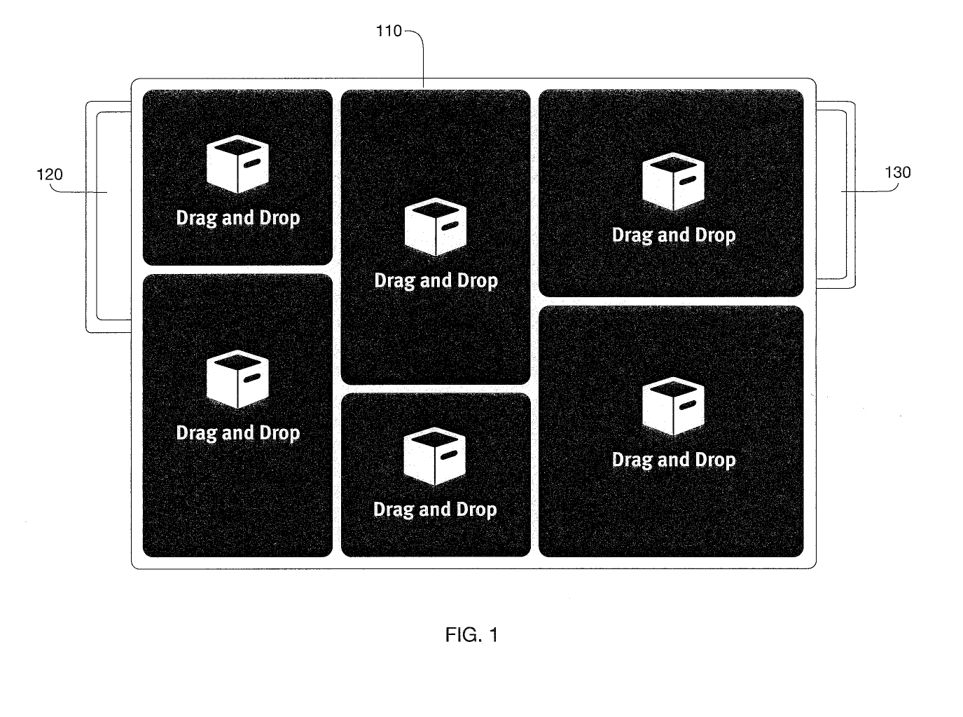

1.3.1 Display rotation of supplied GiftBox images and/or collage templates, scrolling left every 5 seconds. Selection of one or more of the images/templates transfers user under one embodiment to a create GiftBox button or a create page (described further below). FIG. 1 shows a collage template 110 featured in the carousel under an embodiment. Note that collage template 110 features drag and drop boxes available to user for convenient population of boxes with content. Note also the templates 120, 130 in background which are available to user as the user previews templates in the carousel environment.

### Under One Embodiment a Home Page Personalize Section Comprises the First Part of the GiftBox Process Including . . .

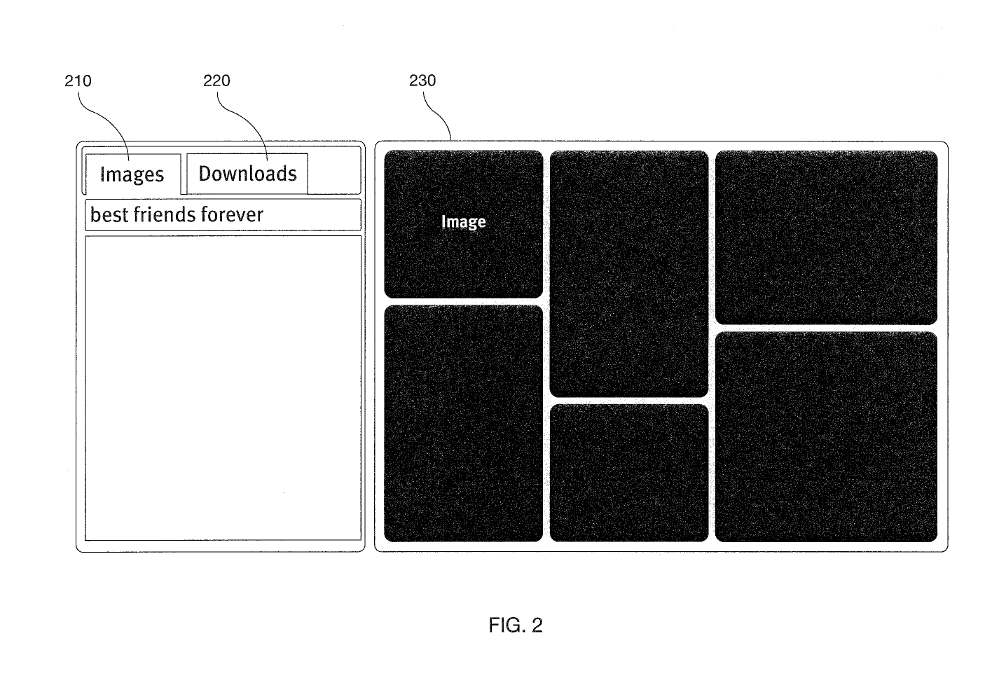

1.4.1 Search social media or local files and upload pictures, videos, audio files, notes, etc using content browsing capability implemented in images and download/upload section set aside for such use on the left or right side of the screen or generally adjacent to a collage of bento boxes. The user may browse for personal content using the images tab 210 (FIG. 2) and corresponding browsing function. FIG. 2 shows an example of browsing using the images tab. (Note that under one embodiment, when a user clicks the images 210 tab, icons may appear between the top of the tab and the search bar and may include Facebook™, Twitter™, Instagram™, and Computer icons. Such icons indicate where the users are looking to grab the images). Alternatively icons may appear below the search bar. Then user may drag and drop content into the bento boxes. FIG. 2 shows image 230 selected and placed by user. The user may analogously use download tab 220 to identify content as further described below. Under one embodiment, user may view downloaded content in the images and download/upload section prior to dragging and dropping the content into the bento boxes. Under an alternative embodiment, a separate workbench section may be provided for visually collecting/organizing content prior to transfer to bento boxes. A separate workbench section may be positioned anywhere near the bento box section.
1.4.2 Drag and Drop content into bento boxes.

### Under One Embodiment a Home Page Add Content Section Explains Second Part of the GiftBox Process Under an Embodiment Including . . .

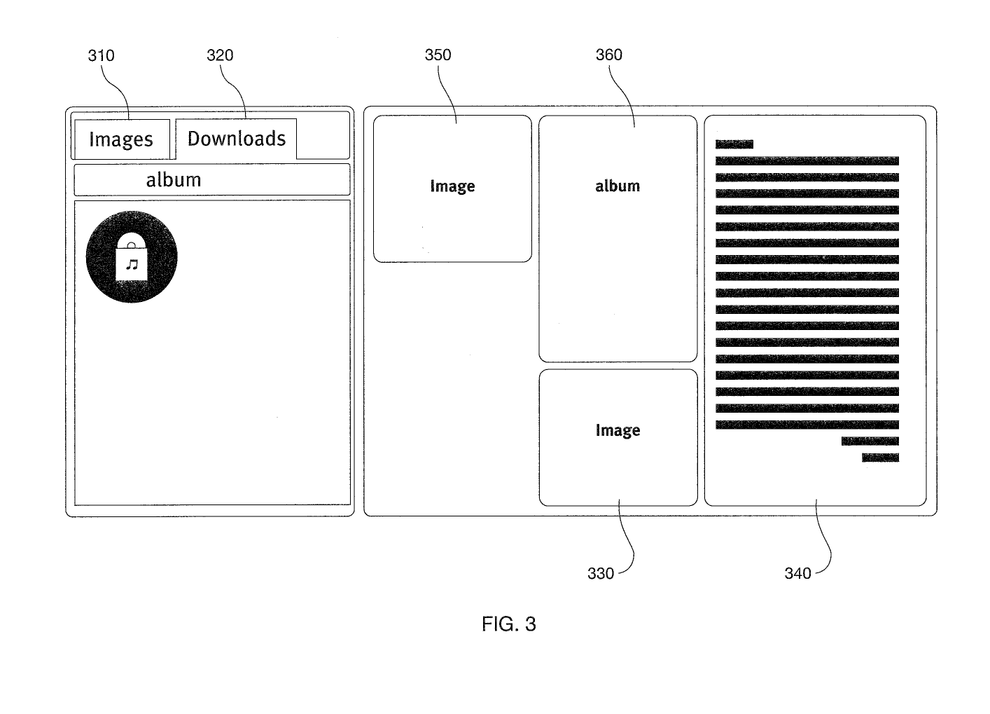

1.5.1 User may shop for and fill the GiftBox with purchased items including singles, albums, ebooks, giftcards, etc. User may use the download/upload section of images and download/upload section to shop for content. The download component provides GiftBox users access to both GiftBox and third party content for purchase. The GiftBox platform may organize such content under the download tab using product icons (e.g. movie icon, ticket icon, etc.) For example, when a user clicks the downloads tab icons may appear between the top of the tab and the search bar (e.g., Music, Movie, TV Show, Books, Tickets, Video Games, Apps icons) to indicate what products a user may explore. (Alternatively icons may appear below the search bar). FIG. 3 shows a user shopping for content using download tab, under an embodiment. FIG. 3 also shows music icon which user may click to initiate search for music content under an embodiment. FIG. 3 shows that user has selected images 350, 330 and placed images 350, 330 into template. Further, a user has used the download tab 320 to identify album 360 and has placed album 360 into template using drag and drop functionality. Under one embodiment, user places original text 340 directly into a box.

### Under One Embodiment a Create GiftBox Link Provides the Following Functionality:

1.6.1 A Create a GiftBox button featured at the top of the Home Page clicks through to the create page (also referred to as the collage page).

### A Create Page Under One Embodiment Includes

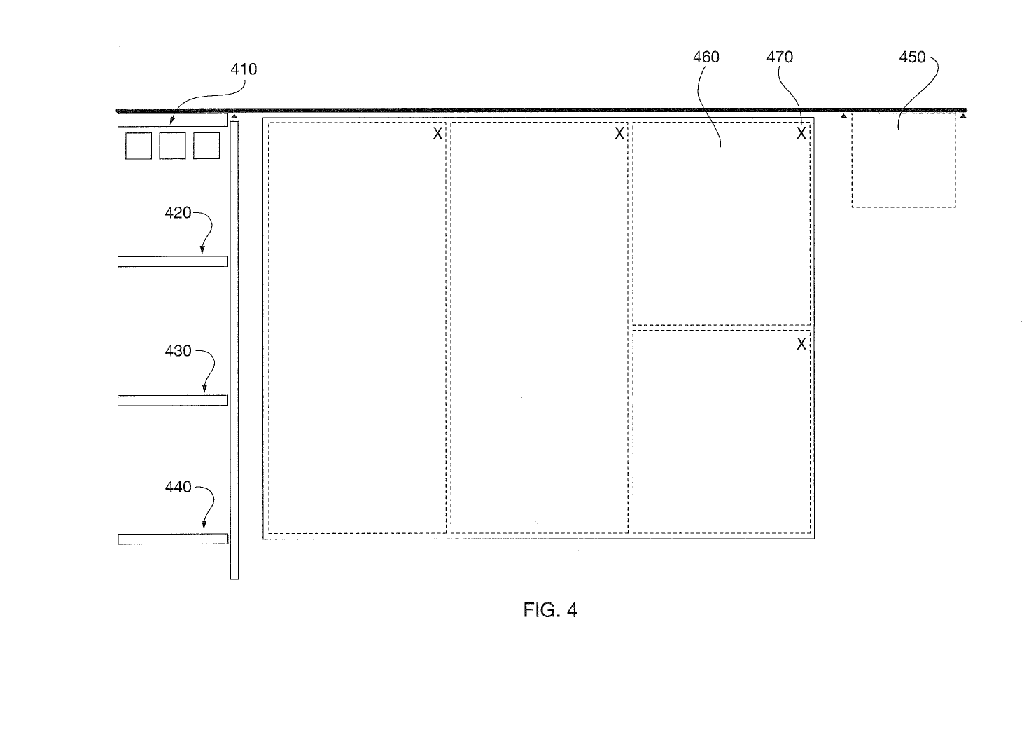

2.0 Select template options include arrangement of bento boxes, border settings, back ground settings and an interactive wrapper selection. Such template selections may be located on left side column adjacent to collage layout but embodiments are not so limited.
FIG. 4 shows an example create page under one embodiment.
2.1 Create a Bento Box style Collage Maker by selecting template and settings. (Note that user may select template and settings here or may already have selected a template with corresponding settings via the template carousel).
2.2 Photo centering and filling the bento box when dragged into template at a location.
2.3 Resizing the photos inside the provided bento boxes
2.4 Ability to choose template for the amount of bento boxes (see 2.0 above)
2.5 Resize bento boxes either vertically or horizontally depending on the template
2.6 A “workbench” sidebar 450 (see FIG. 4) that holds the user's uploaded photos for dragging and dropping into collage
2.7 Remove a photo 460 (see FIG. 4) within a bento box using an X 470 sign in upper right corner of bento box
2.8 Ability to connect to Facebook to retrieve images for collage
FIG. 4 shows a create page collage maker under an embodiment. A user may select a template 410. A user may also select template border 420 and background 430 settings for one or more of the Bento boxes. Further, the user may select a digital wrapper 440 that will digitally “wrap” the content.

### Additional Components of the GiftBox Platform May Include:

### Under One Embodiment of GiftBox Platform, an Accounts Component of the GiftBox Platform Includes:

3.1 Setup GiftBox schema and create MySQL database tables/indexes to support storage of user accounts to include: first name, last name, email address, and password.

### Under One Embodiment of the GiftBox Platform, Registration Using Email Address Includes:

4.1 Display registration input form to allow user to specify first name, last name, email, and password.
4.2 Duplicate email check with “That email address is already in use” feedback.
4.3 Password 8 character check with “Password must be at least 8 characters” feedback.
4.4 Pass all checks creates MySQL user account in status “awaiting confirmation” with “A confirmation email has been sent” feedback.
4.5 Confirmation email with link sent to user email address.
4.6 Executing link confirms user account and moves it to “confirmed” status with “You may now log into GiftBox here” feedback.

### Under One Embodiment of the GiftBox Platform, Registration Using Facebook Account Includes:

5.1 A “Sign Up Using Facebook” button provided on a registration form.
5.2 Display Facebook login dialog using Facebook SDK for Javascript.
5.3 On successful log into Facebook, duplicate registration check or create a user account with information provided by the Facebook authResponse object returned by the Facebook login API (name, email).

### Under One Embodiment of the GiftBox Platform, Login Using Email Address Includes:

6.1 Modify existing Login dialog to authenticate against MySQL database using email/password and set application cookies and session variables.

### Under One Embodiment of the GiftBox Platform, Login Using Facebook Includes:

7.1 A “Login Using Facebook” button on login form.
7.2 The Facebook log in dialog using the Facebook SDK for Javascript.
7.3 On successful log into Facebook, set application cookies and session variables.

### Under One Embodiment of the GiftBox Platform, a Forgotten Password Component Includes:

8.1 “Forgot your password?” link opens dialog requesting email address used to register account.
8.2 Check database: if email exists, send email containing password or feedback email does not exist in system.

### Under One Embodiment of the GiftBox Platform, Logout Includes:

9.1 If user is currently logged into the application, display a “Logout” link.
9.2 Executing “Logout” link releases PHP session and executes Facebook logout function using Facebook SDK for Javascript (if logged in using Facebook).
9.3 Return user to home page.

### Under One Embodiment of the GiftBox Platform, Application Event Logging Includes:

10.1 Create MySQL tables and indexes to support application event logging to include: Date/Time, Event Type, User, Additional Event Info.
10.2 Attach event logging to the following functions: User Registration, Registration Confirmation, User Login, User Logout. Future events may include any application or administration function/action.

### Under One Embodiment of the GiftBox Platform, Application Security Includes:

11.1 Convert existing HTML pages to PHP pages with session management/security check capability. Unauthorized access redirects user to home page.
11.2 Verify all input forms utilize PHP encoding functions to prevent SQL injection.

### Under One Embodiment of the GiftBox Platform, a Send Button May Comprise:

12.1 “Send” button on create page.
12.2 Clicking “Send” button opens dialog with two options: 1. Display/copy GiftBox Link, 2. Email GiftBox From User using GiftBox platform.
12.3 Selecting option #1 displays the link to be copied. Selecting option #2 opens an email input field and “Send” button.

### Under One Embodiment of the GiftBox Platform, Account Maintenance Includes:

13.1 “My Account” link displays basic account information (First Name, Last Name, Email Address) along with “Edit” and “Change Password” buttons.
13.2 “Edit” button opens account information form for modification with “Save” and “Cancel” buttons.
13.3 “Change Password” button opens dialog with “New Password” and “Confirm New Password” fields with “Save” and “Cancel” buttons.

### Under One Embodiment of the GiftBox Platform, Account Administration Includes:

14.1 “Manage Users” link only available to users with “Administrator” privileged accounts.
14.2 “Manage Users” link brings up user search form along with first page of users sorted by Last Name.
14.3 Each user name is a hyperlink that when clicked opens a window containing user account details.
14.4 Account details include all information stored in user account tables plus a chronological listing of application events.

### Under One Embodiment of the GiftBox Platform, a Save GiftBox Function Comprises

15.1 “Save” button on the create page.
15.2 Clicking “Save” prompts the user with a “GiftBox Name” dialog if this is a new giftbox.
15.3 Clicking “Save” opens a progress dialog with “Saving your giftbox . . . ” and a progress bar while saving to the server.

### Under One Embodiment of the GiftBox Platform, a Preview GiftBox Includes

16.1 “Preview” button on the create page.
16.2 Clicking “Preview” opens a dialog telling the user that the GiftBox must be saved in order to preview (if not saved).
16.3 Clicking “Preview” opens a new browser tab that shows the GiftBox being opened (same as recipient view).

### Provide “Images” and “Downloads” Tab to Work Area on Right or Left Side of Create Page Under an Embodiment.

17.1 Under “Images” tab, clicking a “computer” icon opens a file browser to add local image files to work area. Under an embodiment the images tab may also provide connections to Twitter™, Pinterest™, Instagram™, Flickr™, Google Drive™, and any 3^{rd} party website that partners with GiftBox.
17.2 Under “Downloads” tab, clicking a “computer” icon opens a file browser to acid local media files to work area. Under an embodiment, downloads tab may also provide user access to content for purchase from GiftBox or third party vendors including Music, Movies, TV Shows, Music Videos, Lectures, Talk Shows, Video Games, Apps, eBooks, and AudioBooks.

### An Interactive Wrapper of the GiftBox Platform Provides the Following Functionality Under an Embodiment:

### Wrapper Functionality

18.1 Under one embodiment, HTML5 grid mesh that uses a JavaScript based physics engine to give various effects when clicking or swiping or tapping which are, but not limited to, the following: ripping, pulling, tearing, melting, exploding, split, cutting . . . . All leading to the collage. (In essence, a physics engine creates an effect that mimics wrapping paper for the gift/collage).
18.2 Under one embodiment, the grid mesh may be customized by the user from options given by our website, or personally uploaded.
18.3 Under one embodiment, a WebGL based interactive wrapper encloses the collage. A user must interact with (clicking, swiping, tapping . . . ) the digital WebGL wrapper to unveil the collage.
Note that alternative physics engines may be used to implement the digital wrapper.
Under an embodiment, a Create Page of the GiftBox platform includes:

Collage Maker may include following features/functions:

19.1 See above discussion of Create Page component of GiftBox platform for further discussion of Collage Maker.
19.2 Ability to choose template for the amount of bento boxes
19.3 Basic text in the bento box, above/below bento boxes and adjacent bento boxes
19.4 A tab on the sidebar called ‘the workbench’ that holds the user's uploaded photos
19.5 Remove a photo within the bento box using an X sign
19.6 Advanced text box function may include (change font and size, bold/italicize/underline, and alignment)
19.7 “Funky Collage” capabilities (non square shaped collage options)
19.8 Rounded Edges for frame of photos
19.9 Border Width change ability
19.10—Rotate/flip photos within bento box
19.11—Brightness control
19.12—Effects on the pictures and collage as a whole
19.13—Background pattern/image
19.14—Image border change ability

Images Tab:

20.1 Connection to Twitter, Pinterest™, Instagram™, Flickr™, Google Drive™, and any 3^{rd} party website that partners with GiftBox

Downloads Tab:

21.1 Browsing capability to search/shop for local or third party Music, Movies, TV Shows, Music Videos, Lectures, Talk Shows, Video Games, Apps, eBooks, AudioBooks

Workbench:

Can Drag and Drop any Potentially Usable Collage Elements into a Side Bar.

Choose Wrapper:

Can Choose from a Variety of Interactive Wrappers

On the creation page the user can upload data (such as jpeg, png, mp3, mp4, . . . ) or download data from our web store and place it in the user workbench. At this point no data is saved. Once the user drags the data (downloaded from our store, or uploaded by them) into the collage and saves the collage, the collage and all of its elements as a whole are saved to the server. Once the user finishes the collage and clicks the ‘send’ button the collage is saved to the server one final time. When the user sends out the link to be viewed by another user, the link will retrieve the saved collage/GiftBox data from the server. The server will keep track of how many times a given link was viewed and how often data was requested for download.

### A Create Page Under One Embodiment May Include:

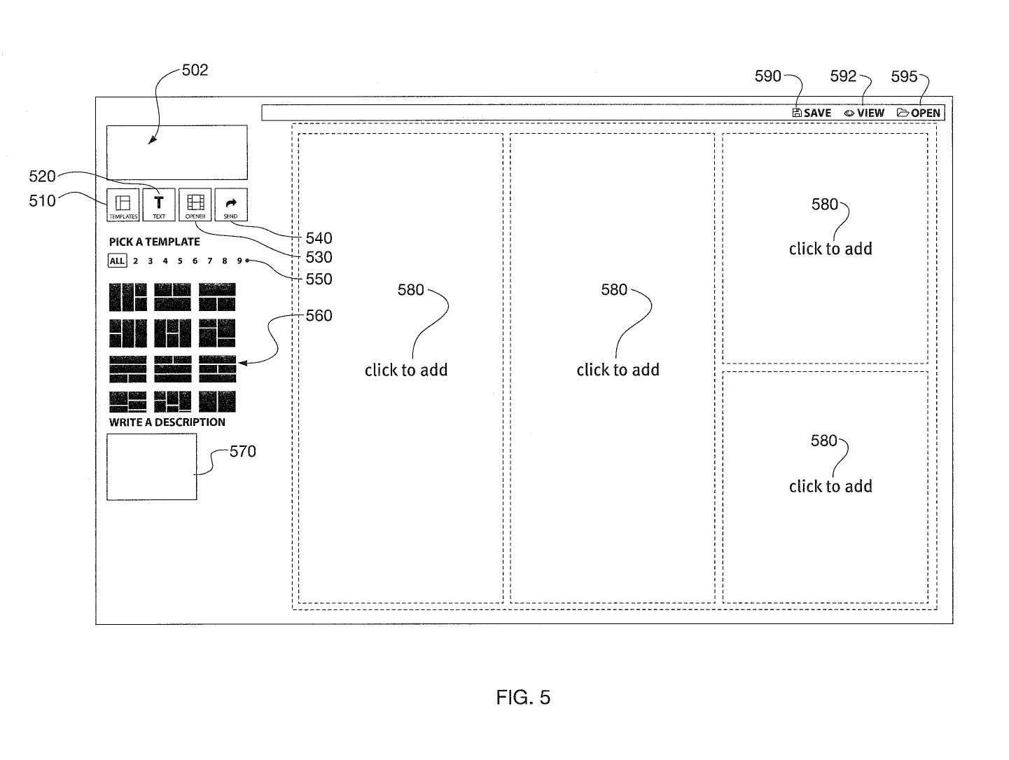

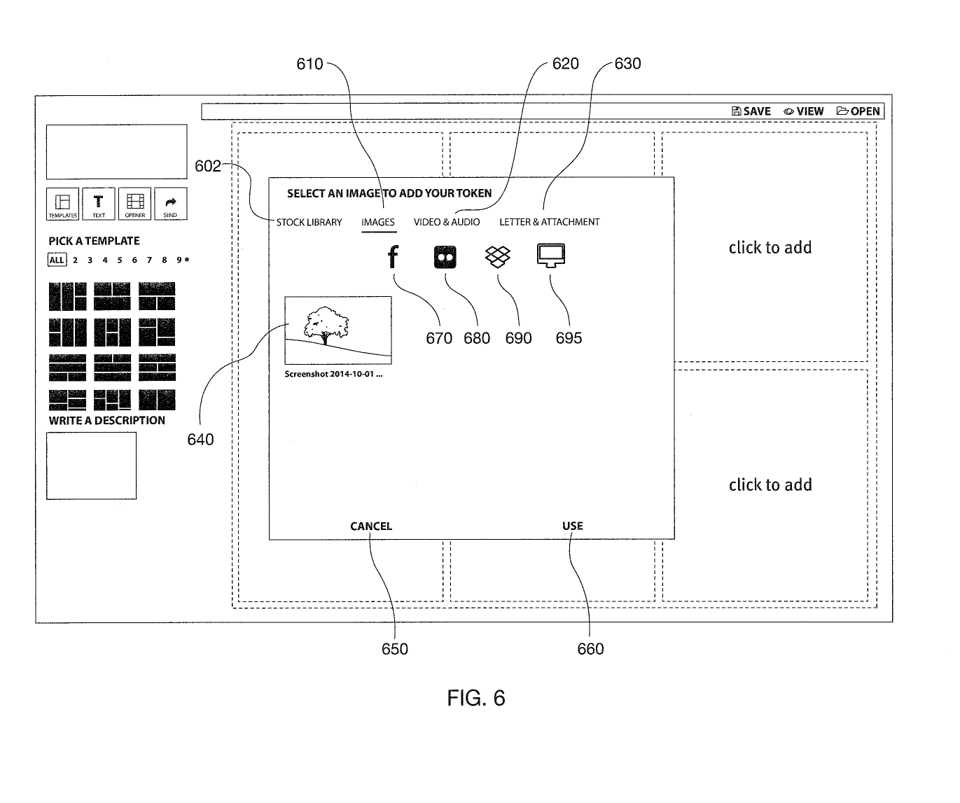

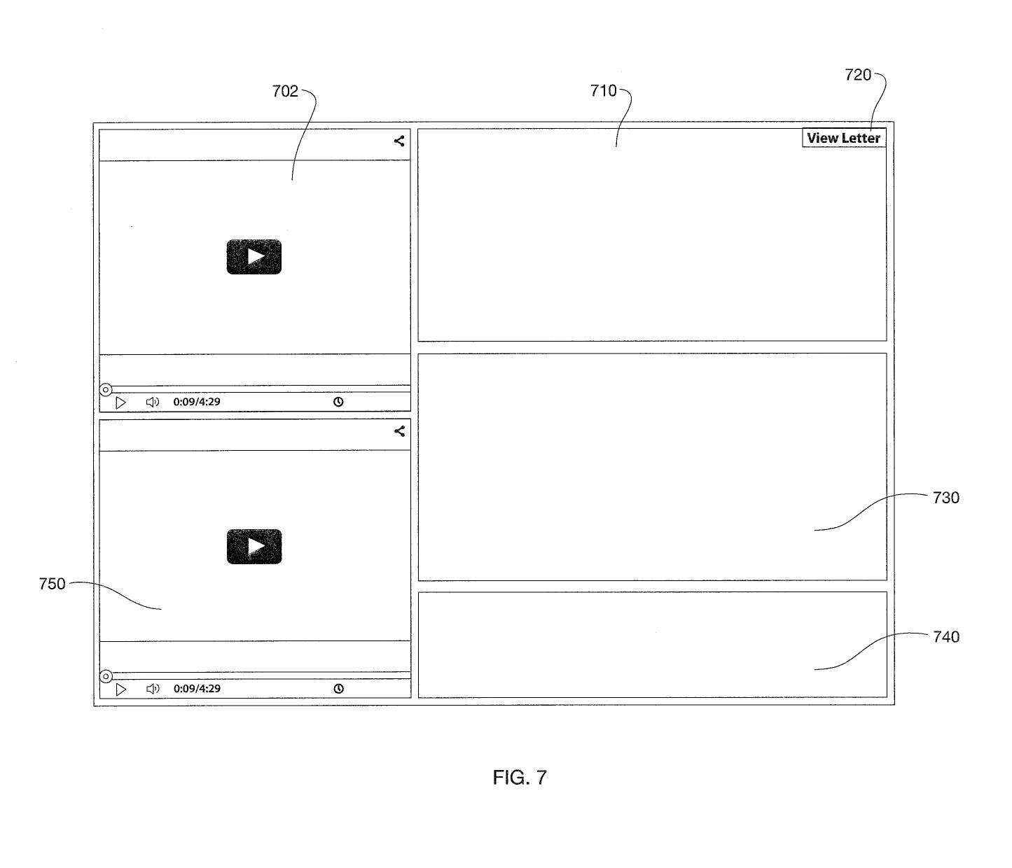

As seen in FIG. 5, The GiftBox logo button 502 returns the user to the home page. Further with respect to FIG. 5 templates button 510 acts like a tab revealing elements 550 and 560 as further described below. The text button 520 acts like a shortcut taking the user to the workbench tab ‘Letters and Attachments’ (FIG. 6, 630) as described below which allows the user to add a letter to the back of a Token Collage. If a letter or other content appears on the back of the Token Collage there will be a tab at the top right of the final “Token Collage” product indicating ‘View Letter’ (FIG. 7, 720) as further described below. The opener button 530 allows the user to add in a digital wrapper/opener that is a JavaScript and CSS animated series of elements that act as an envelope or digital wrapper as described above. The opener button 530 also has a second feature that allows the creator of the Token Collage to redirect the user to a different URL after a set amount of time or at the end of a video presented within the Token Collage. The send button 540 brings the user to a special dialog for sending out Token Collages. FIG. 5, 550 allows a user to browse templates. A user may select ‘all’ templates or may filter the templates shown based on the number of bentos making up the desired Token Collage. For example, if a user selects ‘3’ then the page shows the various configurations of three bento boxes. FIG. 5 shows thumbnails 560 of all templates. If a thumbnail template is selected, then template 580 will change accordingly to the template selected. If the user fills out the ‘Write a Description’ tab 570, the user can post the link in Facebook™ and it will be auto formatted to look like a news story in Facebook's news feed. Clicking any of the bento boxes 580 will bring up the work bench as further described below with reference to FIG. 6. Clicking the save button 590 will save the Token Collage to GiftBox's server. Clicking view 592 will open up a new tab that displays the live Token Collage. Open 595 allows the creator to open previously saved Token Collages.

### A Workbench Found on the Create Page Under One Embodiment Includes:

FIG. 6 shows a workbench screen under an embodiment. The stock library 602 of FIG. 6 is a clickthrough section for enterprise users. This is where company photos, videos, attachments, music, text, quotes, links, and more may be stored and then later selected to add to a Token Collage. The images tab 610 clicks through to where users can select images. The video and audio tab 620 clicks through to where a user may select video and audio files. The letter and attachments 630 tab clicks through to an interface for a user to add a letter on the back of the bento and/or add attachments that a viewer can download. FIG. 6 shows that images 610 is selected which then reveals Facebook™ 670, Flickr™ 680, DropBox™ 690, and local computer 695 options. After a user selects media from one of these content options, the media 640 is then displayed. There may be multiple items in this general display section. A user can click on one or more displayed media in order to select the one more media for use. Selecting the use button 660 then causes GiftBox to fill the contents of the selected bento on a corresponding create page with the selected media. The cancel button 650 closes the workbench without selecting any items.

It should be noted that Facebook™ 670 is one of many integrations that GiftBox offers for users to select image, audio, or video files from

It should be noted that Flickr™ 680 is one of many integrations that GiftBox offers for users to select image files from

It should be noted that DropBox™ 690 is one of many integrations that GiftBox offers for users to select image, audio, or video files from

It should be noted that local computer 695 is one of many options that GiftBox offers for users to select image, audio, or video files from local sources.

### The Front Side of a Token Collage Under One Embodiment Includes:

FIG. 7 shows under one embodiment the front of a finished Token Collage. The collage comprises online video content 702, 750. Such content may comprise YouTube™ videos under one embodiment. The collage comprises an image file 710. Note that tab 720 when clicked or touched will flip the Token Collage around to display the back of the Token Collage that may comprise a letter (or other content) presented to recipient of the collage. The collage comprises one or more image files 730 that may include one or more hyperlinks to other webpages. The collage comprises an image file 740 that may also include a hyperlink to audio content.

### A Bento Editor Found on the Create Page May Under One Embodiment Include:

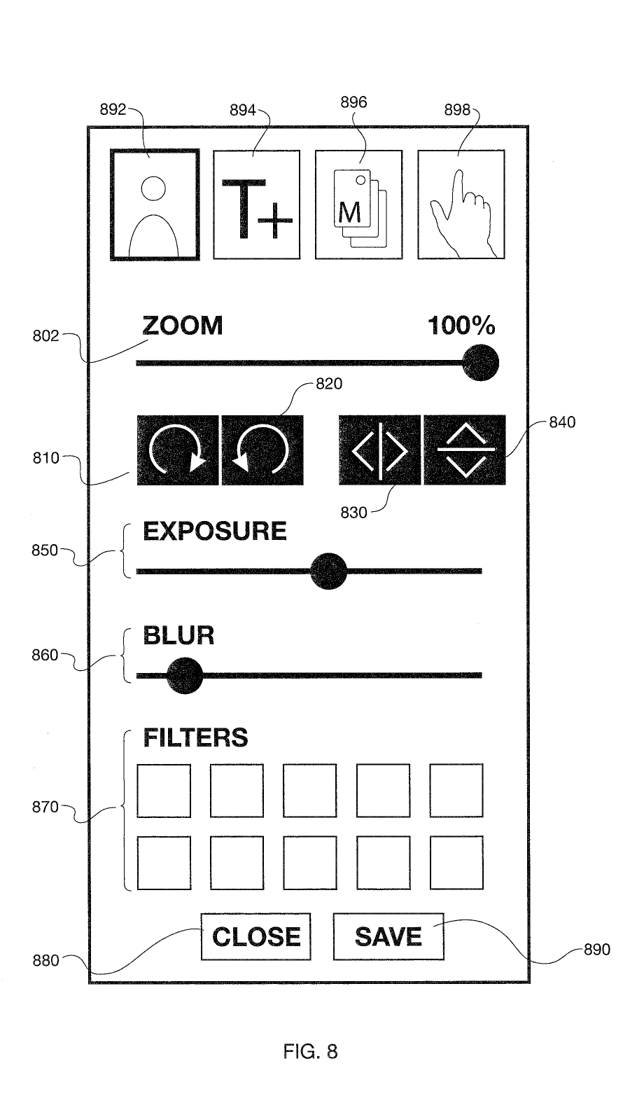

An embodiment of a Bento Editor is outlined in FIGS. 8-11. The bento editor is shown only after a user selects a filled bento box on the workbench page. (See below for a more detailed discussion of workflow leading to use of Bento Editor). Under an embodiment, the Bento Editor affects only one image (or one particular media) at a time. As seen in FIG. 8, the Bento Editor comprises four tabs across the top of the editor interface: photo editor 892, text editor 894, slide editor 896, and interactive editor 898.

FIG. 8 shows the photo editor. Note that the photo editor button 892 is selected. Each feature shown in FIG. 8 provides clickable functionality as described below.

Feature 802 allows the user to zoom into the picture, under an embodiment.

Feature 810 rotates the image clockwise, under an embodiment.

Feature 820 rotates the image counter clockwise, under an embodiment.

Feature 830 transposes the image over the Y axis (vertical axis), under an embodiment.

Feature 840 transposes the image over the X axis (horizontal axis), under an embodiment.

Feature 850 adjusts the exposure on the image, under an embodiment.

Feature 860 adjusts the blur of the image, under an embodiment.

Feature 870 offers various filter options for the creator to apply filter effects to images or other media, under an embodiment.

Feature 880 closes the editor without saving changes, under an embodiment.

Feature 890 closes the editor and saves the changes, under an embodiment.

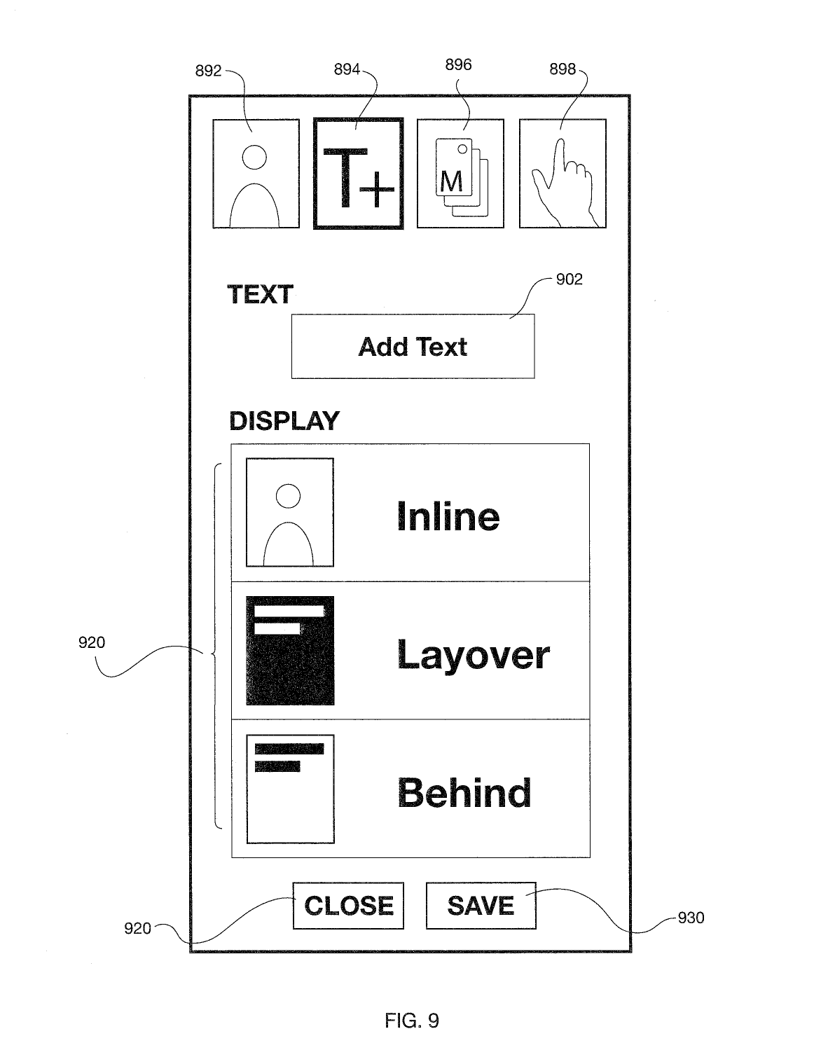

FIG. 9 shows the text editor 894. Note that the text editor button 894 is selected. Each feature shown in FIG. 9 provides clickable functionality as described below.

Feature 902 brings up a dialog box that the user may use to add text to the bento, under an embodiment.

Feature 910 allows user to choose whether the text shows up inline (on top of the image), layover (on top of the image but only when triggered by click/hover/touch/tap), or behind (on trigger by hover/click/touch/tap the bento will flip displaying text on the back of the bento), under an embodiment.

Feature 920 closes the editor without saving changes, under an embodiment.

Feature 930 closes the editor and saves the changes, under an embodiment.

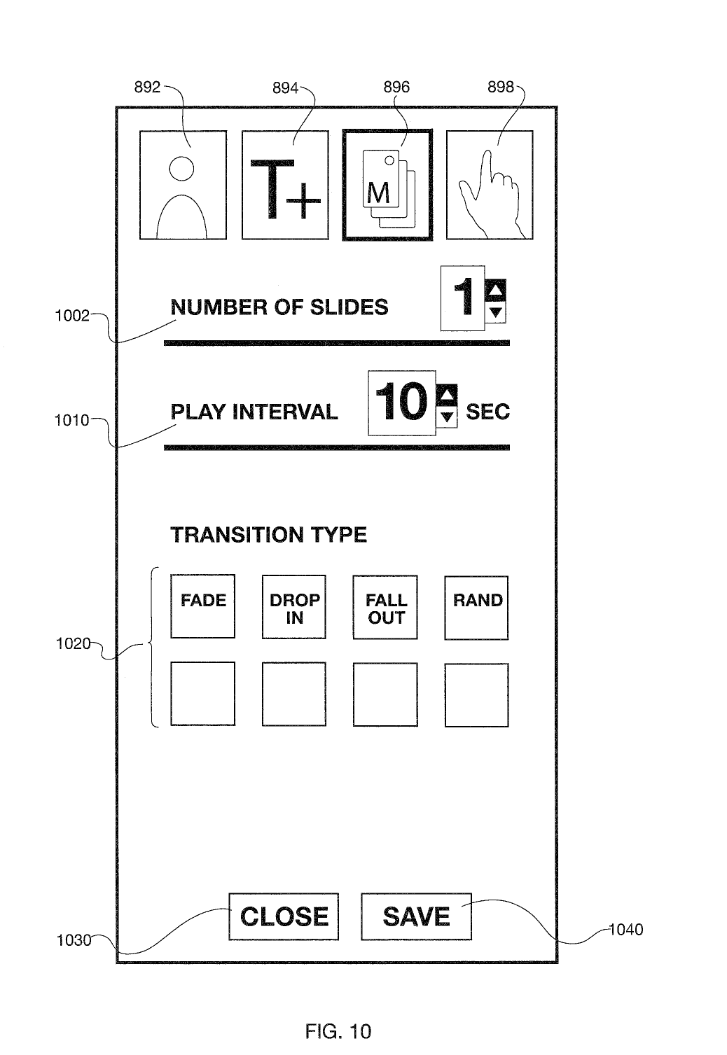

FIG. 10 shows the slide editor 896. Note that the slide editor button 896 is selected. Each feature shown in FIG. 10 provides clickable functionality as described below.

Feature 1002 lets the user add additional slides to the bento (i.e. the bento will slide between various pictures), under an embodiment.

Feature 1010 allows adjustment of play interval which is the amount of seconds that it will take to transition between the various images, under an embodiment.

Feature 1020 features transition type functionality allowing the user to select how the various images of the slide show will transition between one another, e.g. fade, drop in, fall out, or random, under an embodiment.

Feature 1030 closes the editor without saving changes, under an embodiment.

Feature 1040 closes the editor and saves the changes, under an embodiment.

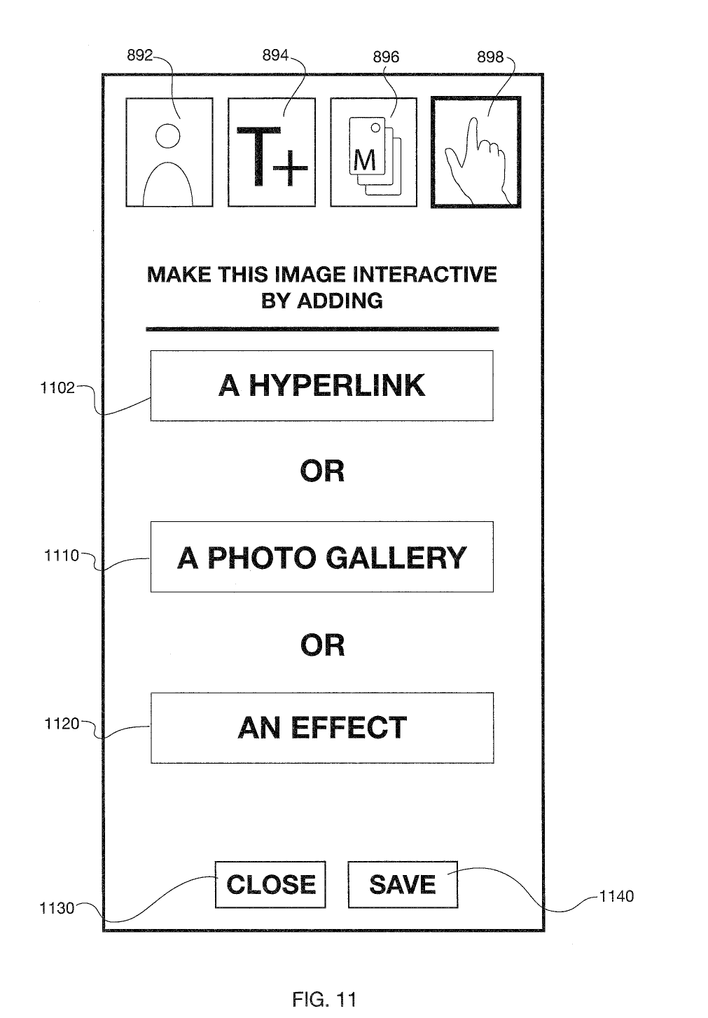

FIG. 11 shows the interactive editor 898. Note that the interactive editor button 898 is selected. Each feature shown in FIG. 11 provides clickable functionality as described below.

Feature 1102 allows the user to add a hyperlink to a given image; making it link to another webpage, under an embodiment.

Feature 1110 allows the user to add a photo gallery. If the image is clicked it may open a full screen photo gallery of scrolling images, under an embodiment. The main difference between the photo gallery and the slide show is that the photo gallery is full screen whereas the slide show is only within the bento (and the slide show is automatic, regardless of the user interacting with the image under one embodiment).

Feature 1120 allows the user to add special effects the collage, under an embodiment. The effects can be triggered by clicks, hover, touch, tap, scroll, type, pinch, and other means. The effects can vary from parallax visuals, to CSS animations and transitions, to re-rendering the Token Collage.

Feature 1130 closes the editor without saving changes, under an embodiment.

Feature 1140 closes the editor and saves the changes, under an embodiment.

Under one embodiment, GiftBox may integrate with any third party content provider to provide content for selection and inclusion into collages using the combination of create, workbench and bento editor screens.

The Workflow of Creating a Token Collage May Under One Embodiment Include:

After the creator has logged in the use can navigate to the create page. After arriving on the create page they can choose a template (element 560) that suits their needs. Then they can select bentos within the template (element 580) which brings up the workbench. From the workbench they can add in images (element 670, 680, 690, 695) or video and audio, which will populate the workbench (element 640). Then the creator can select the desired media from element 640 and then click use (element 660) to add to a specific bento. The user can then add utility to the bento by clicking on a filled bento, which brings up the Bento Editor (see FIG. 11 through 14). After bento edits are completed and each bento is used, the creator can click on ‘save’ (element 590) and then click ‘view’ (element 592). The ‘view’ button will bring up a new tab with the Token Collage which is now finished. The creator at this point can choose between sending the link out by itself, or using GiftBox's send feature (element 540).

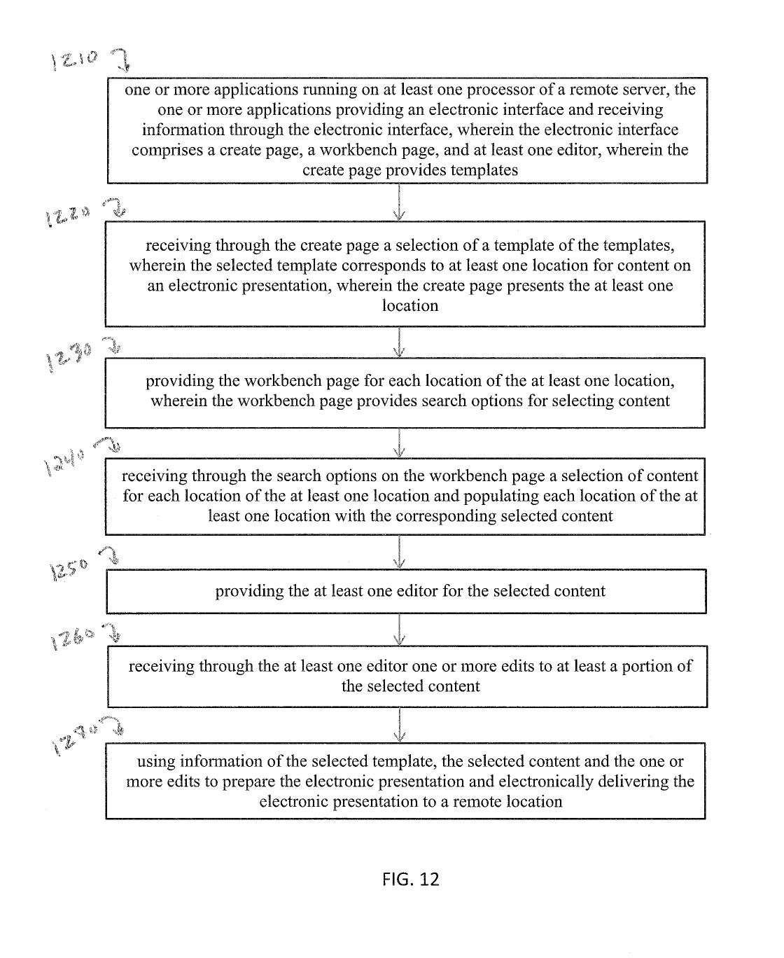

FIG. 12 shows a method for creating and delivering an electronic presentation (i.e. a Token Collage). The method includes step 1210 comprising one or more applications running on at least one processor of a remote server, the one or more applications providing an electronic interface and receiving information through the electronic interface, wherein the electronic interface comprises a create page, a workbench page, and at least one editor, wherein the create page provides templates. The method includes step 1220 comprising receiving through the create page a selection of a template of the templates, wherein the selected template corresponds to at least one location for content on an electronic presentation, wherein the create page presents the at least one location. The method includes step 1230 comprising providing the workbench page for each location of the at least one location, wherein the workbench page provides search options for selecting content. The method includes step 1240 comprising receiving through the search options on the workbench page a selection of content for each location of the at least one location and populating each location of the at least one location with the corresponding selected content. The method includes step 1250 comprising providing the at least one editor for the selected content. The method includes step 1260 comprising receiving through the at least one editor one or more edits to at least a portion of the selected content. The method includes step 1270 comprising using information of the selected template, the selected content and the one or more edits to prepare the electronic presentation and electronically delivering the electronic presentation to a remote location.

There are two primary ways GiftBox receives data. The first is by user upload. When a user is making a collage they have the option of uploading their own data (images, music, video etc. . . . ) into the collage maker. The second option is by connection to a third party resource. This can take form of channel service where we sell third party digital content.

When a user receives a GiftBox link and clicks it, a request is sent to a GiftBox server. The server looks to see if this was uploaded content (i.e. user originated), in which case it does not matter who is requesting the download. If this was content bought by the original user (the giver), then future users (the receivers) who look at the link must sign in to download the content and they are only authorized to download the content if the original user (the giver) specifically purchased it for them.

Under one embodiment, GiftBox data is stored on a server→using GAE (Google App Engine) and MySQL relational database.

Under one embodiment, the GiftBox platform may expand its database/service for each new provider added to the GiftBox network. GiftBox under an embodiment, requests and interacts with each such provider's API to access/retrieve their digital content. When a user purchases the content through the GiftBox platform (in creating a GiftBox), GiftBox funnels the sale to the content provider and stores the saved content on a GiftBox server. API's provided by third parties may facilitate integration of third party content/gift providers under an embodiment. Those API's provide a means to list, select, and purchase digital content for inclusion into a gift package which will be delivered by the GiftBox system.

A user (as gift creator and/or gift recipient) may interact with the GiftBox interface as follows as under one embodiment:

Bob Smith knows that his grandson's 14^{th} Birthday is coming up. He wants to send him tickets to his favorite movie which comes out the same week. He also wants to send him the sound track to the movie. Bob log's on to his GiftBox account and goes to the create page. Under the images tab Bob connects to his Facebook account and adds pictures of him and his grandson to the GiftBox workbench, and then arranges them in the collage how he wishes (under an embodiment). (Under an alternative embodiment, the images tab may also provide content for purchase through third party vendors or GiftBox for the purpose of personalizing the collage.) Next Bob goes under the Downloads/Uploads tabs to either purchase media from GiftBox or Upload his own digital content. Since Bob is looking for the movie soundtrack he clicks the music icon under the download tab and searches in the search box for the movie's sound track. After he finds the soundtrack he drags it in the collage to add it the GiftBox. Next Bob clicks the gift card icon and searches for Regal Cinema. Note that a downloads tab may provide multiple icons that user engages to click through to various categories of content (movies, tickets, apps, etc.) available for purchase from GiftBox or third party vendors. After entering the desired amount for a movie ticket, Bob drags the element into the collage adding it to the GiftBox. After Bob finishes the collage he is prompted to preview the GiftBox. Here Bob realizes that he can add an interactive wrapper to the GiftBox, in essence digitally wrapping the gift. Bob chooses a wrapper from the large selection and proceeds to click send. (Under an alternative embodiment Bob may have already selected such interactive wrapper in selecting collage template and properties.) Here Bob is prompted with two options: would you like GiftBox to send this gift for you, or would you like to send the gift yourself. If Bob selects to have GiftBox send the gift, GiftBox will send the gift at a specified time and date to email or phone. Bob would rather send it himself so he clicks the latter option, leading him to a link. Bob copies the link into a birthday email he sends to his grandson. When his grandson receives the email he clicks the link and is brought to a webpage showing the interactive digital wrapper, after interacting with the wrapper his grandson is brought to the collage his grandfather made, and sees download icons to download the digital gifts bought by his grandfather. Since these items were purchased specifically for the grandson, the grandson must log in to download them. After logging in the soundtrack is downloaded and can be easily added to current file system used to hold music. The gift card is added to the son's account on GiftBox and can be redeemed at any time.

Under an embodiment, the recipient of a GiftBox may receive the GiftBox on any device including computer, smartphone, tablet, etc. that has an internet connection and can open a link to a webpage. Under an embodiment, the recipient of a GiftBox may receive the GiftBox using a native GiftBox application running on a mobile computing device.

There are two delivery options. One the GiftBox may be sent by the GiftBox platform to the user at a specified time and date. This would involve GiftBox sending the recipient an email (or text) with a link to GiftBox. The link renders the saved GiftBox the original user created. Two the original user may send the GiftBox link to the user. The link will render the GiftBox that is saved on the server.

Under one embodiment, GiftBox allows users to list or establish preferences. Users may then opt to have their preferences shown, i.e. if a user is looking to buy a certain other user a present, the first user can see what the other user has on his/her wish list and if anyone already bought it for him/her

Also under one embodiment of the home page the first thing a user may see is a promotional GiftBox. User clicks/swipes the wrapper to unwrap the GiftBox to receive the Collage and can download a free album as one example.

A method is described herein including one or more applications running on at least one processor of a remote server, the one or more applications providing an electronic interface and receiving information through the electronic interface, wherein the electronic interface comprises a create page, a workbench page, and at least one editor, wherein the create page provides templates. The method includes receiving through the create page a selection of a template of the templates, wherein the selected template corresponds to at least one location for content on an electronic presentation, wherein the create page presents the at least one location. The method includes providing the workbench page for each location of the at least one location, wherein the workbench page provides search options for selecting content. The method includes receiving through the search options on the workbench page a selection of content for each location of the at least one location and populating each location of the at least one location with the corresponding selected content. The method includes providing the at least one editor for the selected content. The method includes receiving through the at least one editor one or more edits to at least a portion of the selected content. The method includes using information of the selected template, the selected content and the one or more edits to prepare the electronic presentation and electronically delivering the electronic presentation to a remote location.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The GiftBox platform can be a component of a single system, multiple systems, and/or geographically separate systems. The GiftBox platform can also be a subcomponent or subsystem of a single system, multiple systems, and/or geographically separate systems. The GiftBox platform components can be coupled to one or more other components (not shown) of a host system or a system coupled to the host system.

One or more components of the GiftBox platform and/or a corresponding interface, system or application to which the GiftBox platform is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the GiftBox platform can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the GiftBox platform and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the GiftBox platform and corresponding systems and methods include: microcontrollers with memory (such as electronically erasable programmable read only memory (EEPROM)), embedded microprocessors, firmware, software, etc. Furthermore, aspects of the GiftBox platform and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the GiftBox platform and corresponding systems and methods is not intended to be exhaustive or to limit the systems and methods to the precise forms disclosed. While specific embodiments of, and examples for, the GiftBox platform and corresponding systems and methods are described herein for illustrative purposes, various equivalent modifications are possible within the scope of the systems and methods, as those skilled in the relevant art will recognize. The teachings of the GiftBox platform and corresponding systems and methods provided herein can be applied to other systems and methods, not only for the systems and methods described above.

The elements and acts of the various embodiments described above can be combined to provide further embodiments. These and other changes can be made to the GiftBox platform and corresponding systems and methods in light of the above detailed description.

What is claimed is:

1. A method comprising,
one or more applications running on at least one processor of a remote server, the one or more applications providing an electronic interface and receiving information through the electronic interface, wherein the electronic interface comprises a create page, a workbench page, and at least one editor, wherein the create page provides templates;
receiving through the create page a selection of a template of the templates, wherein the selected template corresponds to at least one location for content on an electronic presentation, wherein the create page presents the at least one location;
providing the workbench page for each location of the at least one location, wherein the workbench page provides search options for selecting content;
receiving through the search options on the workbench page a selection of content for each location of the at least one location and populating each location of the at least one location with the corresponding selected content;
providing the at least one editor for the selected content;
receiving through the at least one editor one or more edits to at least a portion of the selected content;
using information of the selected template, the selected content and the one or more edits to prepare the electronic presentation and electronically delivering the electronic presentation to a remote location.

2. The method of claim 1, the preparing the electronic presentation including associating the electronic presentation with one or more digitally animated effects.

3. The method of claim 2, the electronically delivering the electronic presentation including requiring viewing of the one or more digitally animated effects prior to viewing the electronic presentation.

4. The method of claim 3, the requiring the viewing comprising requiring at least one input from a recipient of the electronic presentation.
